(19) United States
(12) Patent Application Publication
(10) Pub. No.: US 2011/0005124 A1
(43) Pub. Date: Jan. 13, 2011

(54) INSECT TRAP WITH A FLOWING TRAPPING FLUID

(76) Inventors: Rick A. Gelette, Calgary (CA); Karen Renee Downey, Calgary (CA)

Correspondence Address: SEAN W. GOODWIN, 222 PARKSIDE PLACE, 602-12 AVENUE S.W., CALGARY, AB, T2R 1J3, CA

(21) Appl. No.: 12/835,480

(22) Filed: Jul. 13, 2010

Related U.S. Application Data
(60) Provisional application No. 61/225,005, filed on Jul. 13, 2009.

(51) Int. Cl. A01M 1/04

(52) U.S. Cl. 43/113

(57) ABSTRACT

An insect trap for attracting, entrapping and killing flying insects comprises a light source emitting a light suitable to attract insects, a translucent wall and a flowing trapping fluid. A distributor directs a fluid film of trapping fluid onto an outer surface of the translucent wall. The fluid film flows down the translucent wall and intercepts insects attracted by the emitted light. The insects come into direct contact with the fluid film and are trapped by the trapping fluid. Trapped insects are filtered from the trapping fluid by a removable filter. The trapping fluid is collected in a reservoir and recirculated to the distributor by a pump.

### CROSS REFERENCE TO RELATED APPLICATIONS

This application claims the benefits under 35 U.S.C 119(e) of the U.S. Provisional Application Ser. No. 61/225,005, filed Jul. 13, 2009, which is incorporated fully herein by reference.

### FIELD OF THE INVENTION

This invention relates to insect traps. More specifically, this invention relates to insect traps having an internal light source as an attractant and a flowing trapping fluid used to entrap and kill insects.

### BACKGROUND OF THE INVENTION

Mosquitoes, flies, moths, and other flying insects have been a nuisance to humankind, and have been able to get into unwanted places, such as homes. Insect bites are also common, and can cause, at the very least, uncomfortable sensations for a prolonged period of time, and at worst can transmit diseases. It is known that certain insects are known to be carriers of virulent diseases such as the West Nile Virus.

Traps for insects, particularly flying insects have been known and used for a long time. Traps are known to use an attractant one of sort, such as a light source, to lure insects towards the trap.

U.S. Pat. No. 4,117,624; U.S. Pat. No. 4,654,998; U.S. Pat. No. 4,700,506; and U.S. Pat. No. 5,044,112 all use an adhesive surface, which is sticky, to trap insects. Thus insects that become entrapped on the adhesive surfaces will remain stuck on the surface until such time as the adhesive is disposed of. The adhesive surface is finite and there may be a long period of time between removal of the adhesive, depending on the number of insects trapped.

U.S. Pat. No. 5,203,816 teaches an electric flea trap which may be used to trap mosquitoes and other flying insects. The trap has an internal light source housed in a transparent cylindrical housing. The housing is further encased in a tubular member that has a finite adhesive outer surface which traps insects.

U.S. Pat. No. 5,311,696 teaches a trap having a light for attracting insects and a shallow reservoir of soapy water into which insects inadvertently fall, causing them to drown. The surface of the soapy water is finite and may be replaced or replenished as often as it is necessary or desired.

U.S. Pat. No. 4,366,643 teaches a trap that uses a fluorescent light for emitting a light of a frequency for attracting such insects. The trap also has a fluid reservoir for entrapping and killing insects that inadvertently fall into it while flying towards the light attractant. The fluid reservoir contains a trapping fluid with a finite surface to entrap insects.

GB Patent 0238457 teaches an insect trap that has a reservoir for automatically replenishing trapping fluid when the trapping fluid is low. The trapping fluid, having a finite surface for trapping insects, is contained in a second reservoir. This trap further teaches a light source submerged under the trapping fluid, which warms the trapping fluid, providing for a secondary source of attractant for insects.

U.S. Pat. No. 6,840,003 teaches an insect trap that provides a plurality of light sources to effectuate efficient insect trapping no matter where or when the trap is used. The trap further has a means for easily emptying and disposing the trapped insects comprising a releasable netting.

There is a need for an aesthetically pleasing insect trap that replenishes or refreshes a trapping surface such that a maximum possible amount of trapping surface area is constantly exposed to trap insects.

### SUMMARY OF THE INVENTION

An insect trap combines an insect attracting light source positioned behind a one translucent wall and a film of flowing insect-trapping fluid. The one translucent wall has an inside surface, an outer surface and an upper end. The light source is located adjacent the inside surface of the translucent wall for emitting insect-attracting light, visible to insects at the outer surface thereof. The trapping fluid flows in a fluid film down the outer surface of the translucent wall, the trapping fluid being distributed at the upper end of the translucent wall.

In operation, the trapping fluid is pumped from a fluid reservoir to a distributor. A plurality of orifices on the distributor directs the trapping fluid onto an outer surface of at least one translucent wall. A film of trapping fluid flows down the outer surface of the translucent wall. Light is emitted, from an inside surface, through the translucent wall, the outer surface, and through the flowing film of trapping fluid.

Insects are attracted to the trap by the emitted light. As they fly towards the light source they come into direct contact with the flowing film of trapping fluid, becoming entrapped in the fluid. The entrapped insects flow downwards with the trapping fluid, and are collected from the trapping fluid by a removable filter. The removable filter may be cleaned as necessary or desired to dispose the collected insects.

The flowing film of trapping fluid provides a constant and replenished trapping surface with a maximum possible surface area exposed to insects. The flowing trapping fluid is also aesthetically pleasing and may be used to accessorize a landscaped yard all the while maintaining the yard free of insects.

In a broad aspect, an insect trap has at least one translucent wall with an inside surface, an outer surface and an upper end, at least one light source located adjacent the inside surface of the at least one translucent wall for emitting insect-attracting light, visible to insects at the outer surface thereof, and a distributor for directing trapping fluid in a fluid film down the outer surface of the at least one translucent wall.

In another broad aspect, a method of trapping insects is disclosed. The method comprises directing an insect-attracting light through an inside surface of at least one translucent wall to an outer surface of the at least one translucent wall and flowing a trapping fluid down the outer surface. Insects are attracted towards the outer surface by the insect-attracting light. The insects are caused to come into direct contact with the trapping fluid; trapping the insects with the trapping fluid.

The trapped insects can be removed by a filter and the trapping fluid can be recirculated.

### BRIEF DESCRIPTION OF THE FIGURES

FIG. 1 is a schematic representation of the operation of an embodiment of the present invention illustrating a flying insect flying towards a flowing film of trapping fluid, attracted by a light behind the trapping fluid;

FIG. 2 is a perspective view of an embodiment of the present invention, showing an insect trap having a base supporting a housing with one translucent side wall, and a removable filter;

FIG. 3 is a side view of the embodiment in accordance to FIG. 2, illustrating the placement of a distributor operatively connected to a fluid recirculation pump by a conduit, and a light source;

FIG. 4 is a perspective view of the housing of the embodiment in accordance to FIG. 2, illustrating one translucent side wall;

FIG. 5A-5E are perspective views of various embodiments of the present invention;

FIG. 6 is a perspective view of the base of the embodiment in accordance to FIG. 2;

FIG. 7 is a perspective view of the distributor of the embodiment in accordance to FIG. 2, illustrating the plurality of orifices along the end portion of the distributor; and

FIG. 8 is a side view of the distributor in accordance to FIG. 7.

### DETAILED DESCRIPTION OF THE INVENTION

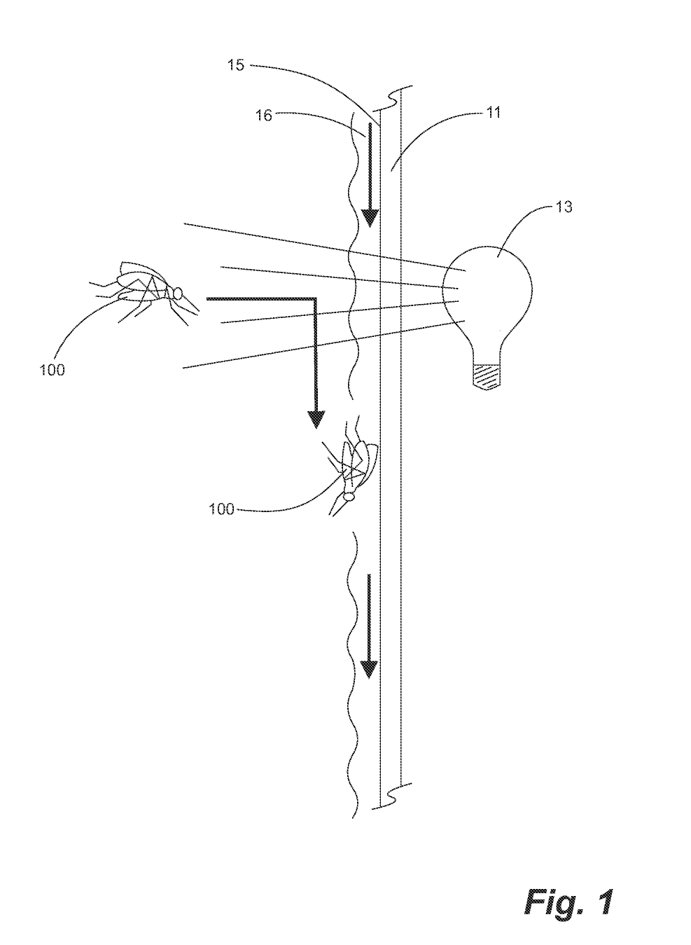

FIG. 1 is a schematic representation of the operation of the insect trap of the present invention. A mosquito or any other flying insect 100 is attracted towards a light source 13 positioned behind a translucent wall 11. The translucent wall 11 can include glass or plastic based materials such as plexiglass. Trapping fluid 16 flows down an outer surface 15 of the translucent wall 11. The trapping fluid 16 can flow as a sheet a fluid film which can be substantially continuous or discontinuous. The terminology fluid film used herein includes continuous and discontinuous coverage of the outer surface. The attracted insect 100, in its attempts to reach the light source 13, comes into direct contact with the flowing trapping fluid 16 and becomes entrapped therein.

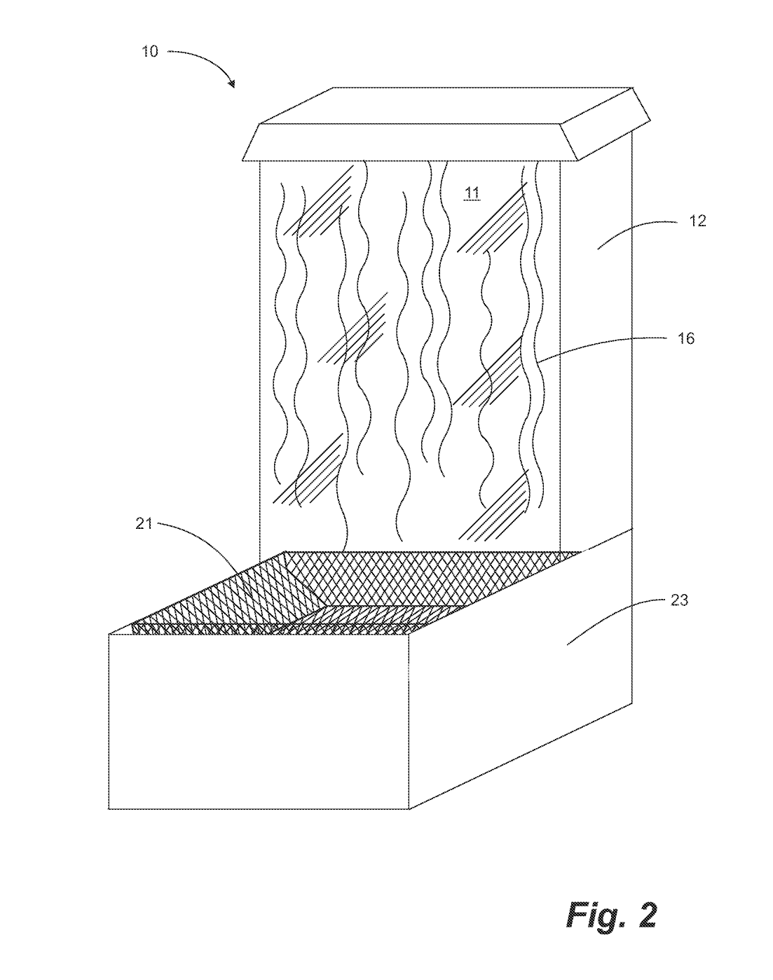

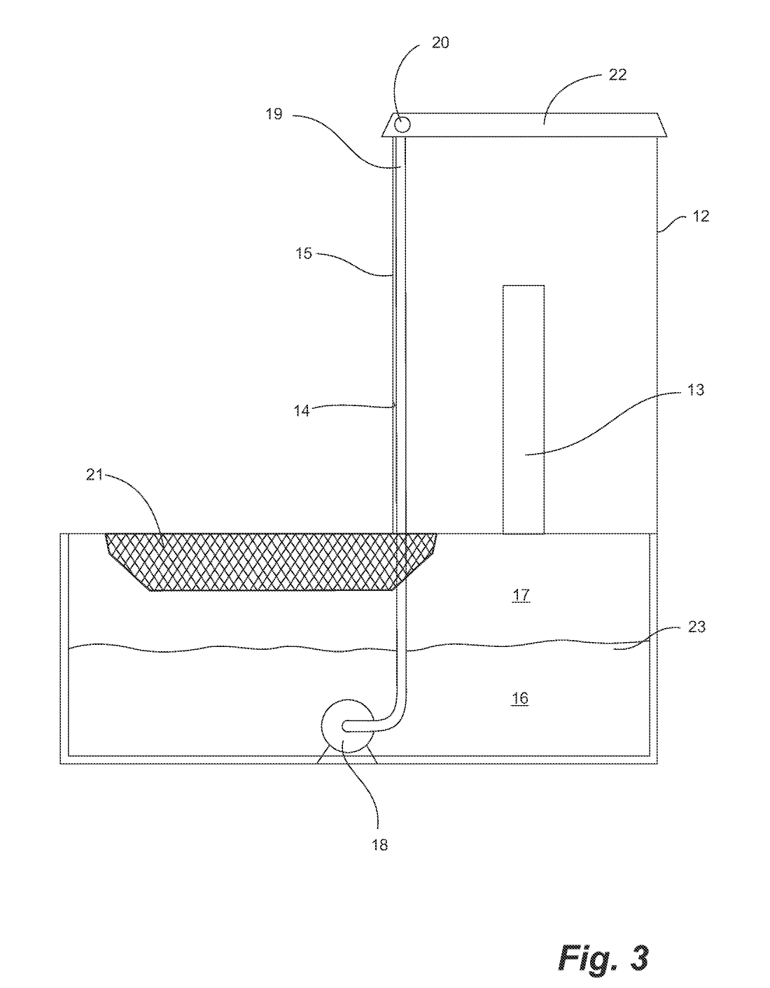

With reference to FIGS. 2 and 3, an insect trap 10 comprises the at least one translucent wall 11 which is oriented substantially upright and typically supported in a housing 12. A light source 13 is located inside the housing 12 and adjacent the translucent wall 11.

The light source 13 emits a light suitable to attract insects. The emitted light travels through an inside surface 14 of the translucent wall 11 to an outer surface 15, and passes through the flowing trapping fluid 16. The emitted light is visible to the insects.

A suitable trapping fluid 16, and shown as squiggly lines on FIG. 2, is selected for entrapping insects. The trapping fluid 16 is caused to flow down the outer surface 15 of the translucent wall 11, forming a fluid film. Insects, attracted by emitted light, fly towards the light source 13, and are intercepted by the fluid film of trapping fluid 16.

The trapping fluid 16, pooled within a reservoir 17, is circulated by a fluid recirculation pump 18. The trapping fluid 16 is pumped from the reservoir 17, through a conduit 19 to a distributor 20 for recirculating and distributing the trapping fluid along an upper end of the outer surface 15 of the translucent wall 11. The film of trapping fluid 16 flows down the outer surface 15 and back into the reservoir 17.

A removable filter 21, such as a screen, positioned below the translucent wall 11, intercepts the trapping fluid 16 for collecting, filtering or removes trapped insects 100 therefrom. The filter 21 is easily removable for disposal of the insects 100 and cleaning of the insect trap 10.

A decorative shroud 22 can cover the insect trap 10 to make the insect trap 10 more aesthetically pleasing.

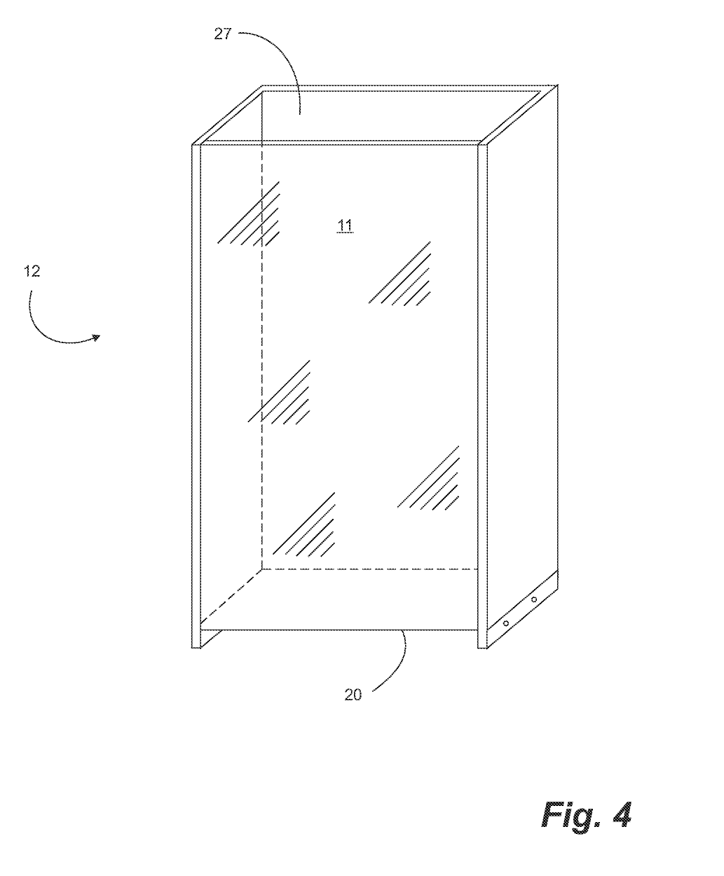

With reference to FIG. 4, an embodiment of the housing 12 is shown. The housing 12 is open ended at both its top end 27 and bottom end 28. The housing 12 is formed of at least one translucent wall 11 having an inside surface 14 and an outer surface 15. The housing 12 is adapted to be supported on a base 23 at its bottom end 28.

A person of ordinary skill in the art would appreciate that the overall shape of the housing 12 is not important, so long as the housing 12 has at least one translucent side wall 11. The balance of any additional walls of the housing 12 can be opaque which reduces expense and provides directional orientation of the translucent wall 11.

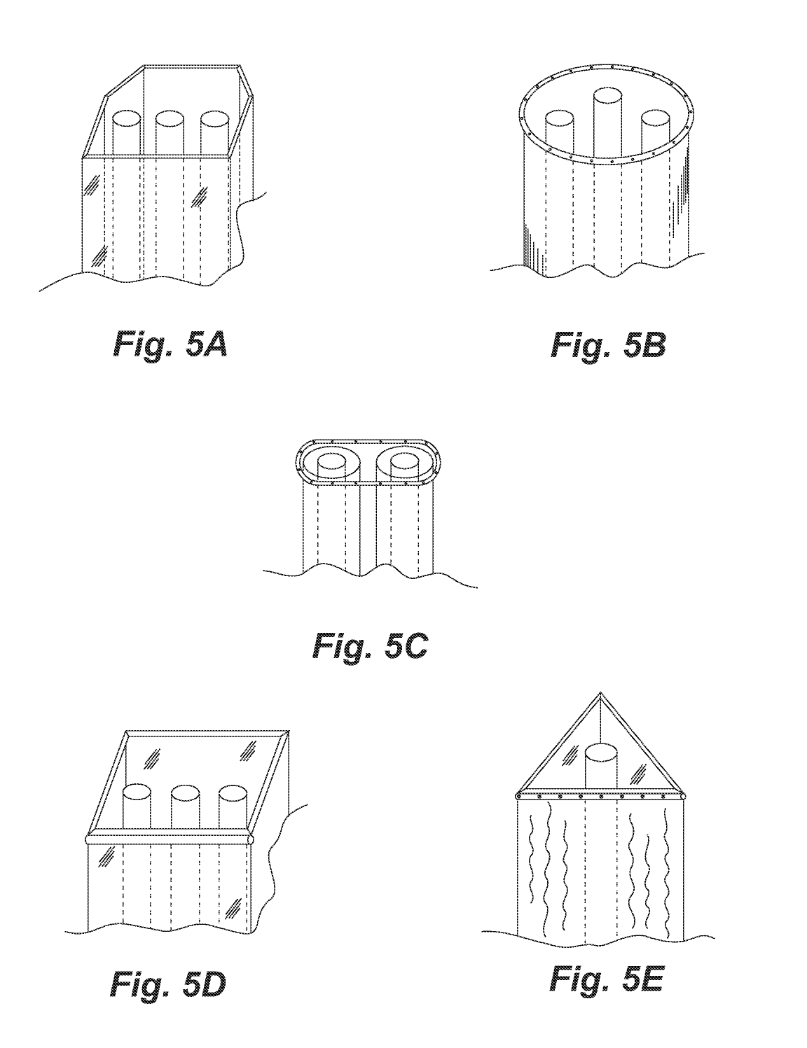

For example, FIGS. 5A to 5D illustrate other embodiments of the instant insect trap 10. FIG. 5A illustrates an embodiment having a uniquely shaped housing with a single translucent wall. FIG. 5B illustrates an embodiment having a single translucent wall that is cylindrical in shape. FIG. 5C illustrates an embodiment that employs two separate translucent walls as tubes, each of which is cylindrical in shape and having its own light source, but both cylinders being served by a single distributor. FIG. 5D is an illustration of an embodiment having at least two translucent walls, while FIG. 5E illustrates a triangular shaped housing having a single translucent wall and additional walls being opaque. The insect trap 10 is most effective if each translucent wall 11 is configured with a flowing film of trapping fluid 16.

Returning back to FIG. 3, the light source 13 is placed adjacent the inside surface 14 of the at least one translucent wall 11 and is placed in a position such the light source 13 is oriented towards the inside surface 14 maximizing the amount of light emitted towards an environment occupied by insects. Insects attracted to the emitted insect-attracting light come into direct contact with the fluid film and are trapped by the insect trapping fluid.

In alternate embodiments, reflective materials may be placed around the light source 13 opposite the inside surface 14, to reflect any emitted light travelling away from the inside surface 14, back towards the inside surface 14 and out into the environment.

Applicant believes that an increase in the amount of light emitted allows the light to travel farther into the environment, attracting more insects 100 towards the insect trap 10 from farther distances. Thus, those skilled in the art would understand that if there were more than one translucent wall, each of the translucent walls could have at least one light source emitting therethrough.

Applicant believes that any light source capable of emitting bright light would be sufficient for the purposes of attracting flying insects. Light sources can include incandescent lamps, fluorescent lamps, and even LED lamps.

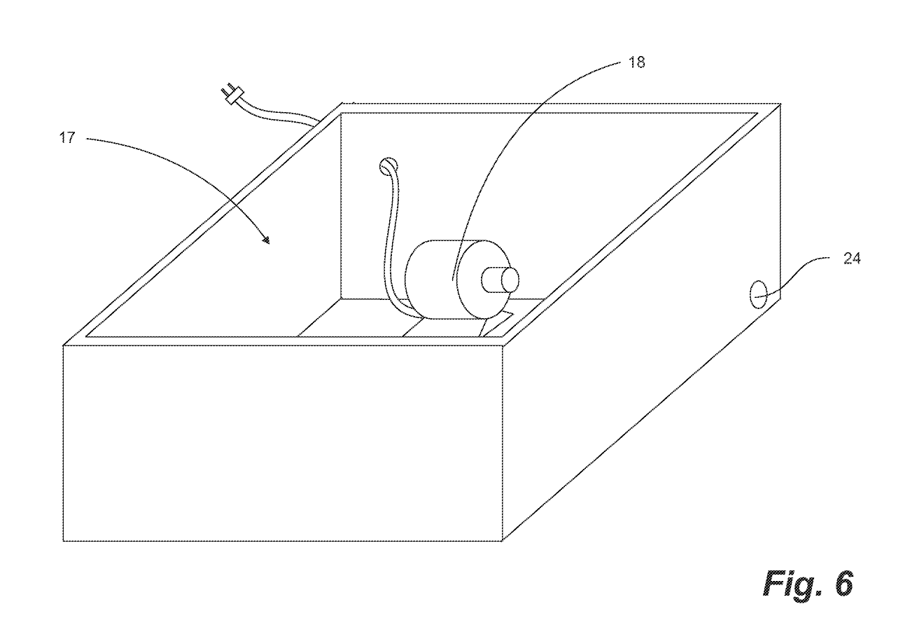

With reference to FIG. 6, an embodiment of the base 23 can have four walls 31a-31d and a bottom 31e defining an opened top fluid reservoir 17. The base 23 has a opening 24 to allow drainage of the reservoir 17. The opening 24 can be located on any one of the side walls 31a-31d or the bottom wall 31e. The opening 24 can be plugged by a cap or by any other means known in the art (not shown).

Those skilled in the art would appreciate that in alternate embodiments, the base 23 can have a single wall and a bottom wall, defining an opened top reservoir that is circular or oval in shape. Other embodiments of the base 23 can have three or more walls with a bottom wall appropriately shaped.

The fluid recirculation pump 18 is shown positioned in the base 23 and within the reservoir 17. In an alternate embodiment, the pump 18 can be positioned outside of the reservoir 17 to allow easier access to the pump 18, for servicing of the pump 18.

The fluid circulation pump 18 has sufficient capacity for circulating viscous trapping fluids up to the distributor 20. The capacity of the pump 18 required will vary depending on the viscosity of the trapping fluid used, the height of the insect trap 10, and the amount of flow of the trapping fluid over the outer surface 15.

A pump having a lower capacity can result in premature failure or produce a trapping fluid flow that has unpleasant aesthetics. A pump with excessive capacity can produce a trapping fluid flow rate that is too quick to sufficiently entrap insects coming into contact with it.

For example, Applicant has found that using mineral oil as a trapping fluid in an insect trap having a height of 5 feet tall would require a pump that is rated at about 1200 gallons per hour. The use of such a pump produces a flow of trapping fluid 16 sufficient to entrap insects 100 when they come into direct contact, as well as produce a fluid flow that is pleasant to view. Applicant has found that for an insect trap 10 that is 3 foot tall, a pump having a 700 gallons per hour capacity was sufficient.

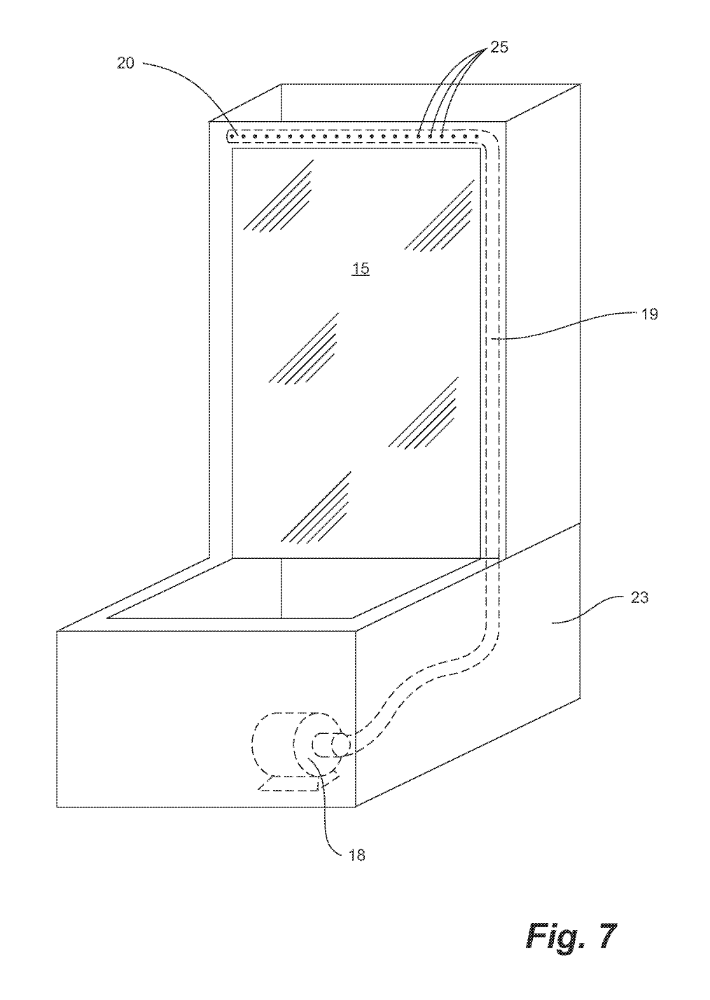

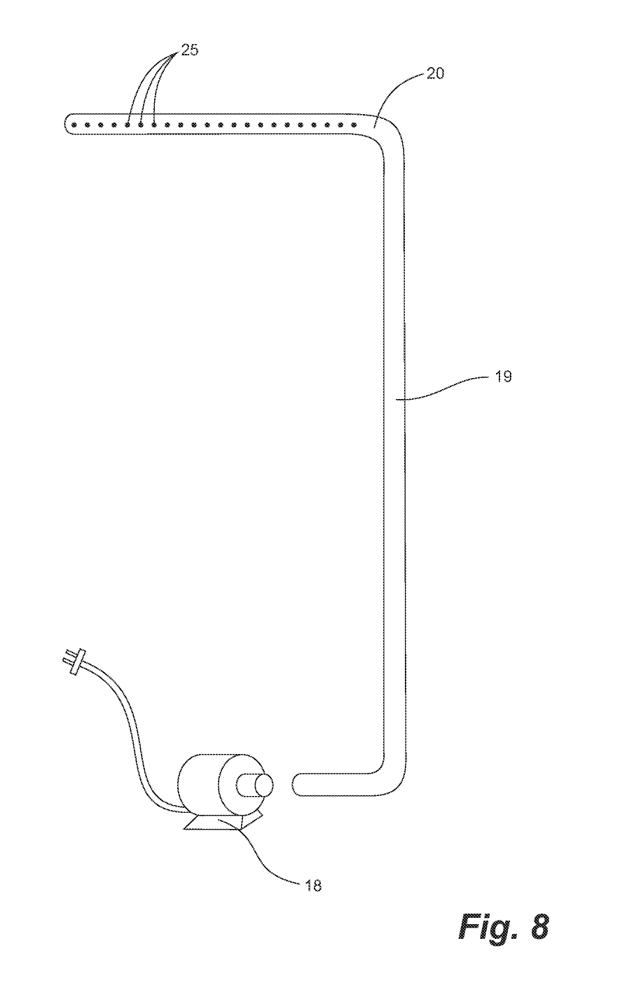

With references to FIGS. 7 and 8, illustrated is a distributor 20 that is operatively connected to the fluid recirculation pump 18 by a conduit 19. The distributor 20 has a plurality of orifices 25 evenly spaced along the entire length thereof, directing trapping fluid 16 from the distributor 20 out onto the outer surface 15 of the at least one translucent wall 11. The trapping fluid 16 flows from the distributor 20 and flows down the outer surface 15 as a film, continuously replenishing a trapping surface such that a maximum possible amount of trapping surface area is constantly exposed to trap insects 100.

In operation, the reservoir 17 of the insect trap 10 is filled with a suitable trapping fluid 16. Suitable trapping fluids 16 can be visually clear and environmentally friendly, so as to increase the ease of disposing used trapping fluid 16. Applicant notes that mineral oil is a good example of a trapping fluid 16 as it is clear, environmentally friendly and viscous. A clear trapping fluid 16 is preferable as it does not block or hinder light emitted to attract insects 100.

Applicant believes that fluids that are higher in viscosity would likely serve as better trapping fluids 16 because trapped insects 100 will have a more difficult time in escaping from a viscous trapping fluid 16.

Applicant notes, however, that trapping fluids 16 that have higher surface tension do not serve as better trapping fluids and in fact are worse than trapping fluids with lower surface tension. Applicant has found that insects are less likely to be entrapped in trapping fluids having higher surface tension.

The fluid recirculation pump 18 circulates the trapping fluid from the reservoir 17, through the distributor 20, and onto the outer surface 15 of the at least one translucent wall 11. The plurality of orifices 25 directs the trapping fluid from the distributor 20 onto the outer surface 15. A film of trapping fluid slowly flows along the outer surface 15, downwards towards the filter 21.

The at least one translucent wall 11, such as made from tempered glass or plexiglass or other translucent plastic material, permits emitted light from the light source 13 to pass through and shine into an environment where insects are present. The emitted light attracts insects 100 towards it and ultimately causes the insects to come into contact with the flowing film of trapping fluid 16.

Insects 100 caught in the flowing film of trapping fluid 16 are unable to escape and thus flow into the removable filter 21, where the continuous flow of trapping fluid causes the trapped insects to drown.

As the trapped insects 100 are removed from the flowing trapping fluid 16, the trapping fluid 16 reenters the reservoir 17 and is ready to be pumped t0 the distributor 20, to begin the cycle again.

As more and more trapped insects 100 are filtered out of the trapping fluid by the filter 21, dead insects will collect in the filter 21. The filter 21 can be removed to allow easy disposal of the dead insects.

Applicant notes that evaporative and other losses, due to exposure of the trapping fluid to the environment, will cause the amount of trapping fluid to decrease over time. Thus, periodic refilling of the trapping fluid may be required.

Although this present invention illustrates a fluid recirculation pump 18 powered by alternating current (AC), alternate embodiments can include pumps that are powered by direct current (DC), solar power, wind power and other sources of energy. Those embodiments using solar energy can also include batteries to store the energy for use when the sun is not shining.

Further embodiments can include mechanisms to conserve power being used by the pump. Such mechanisms can include a photocell or other timing mechanisms, such as a timer, operatively connected to the pump to turn the pump off when the pump is not being used.

The Applicant notes that the present embodiment relies on a light source as a primary attractant for insects. This requires an environment with low lighting conditions. In environments where there are bright light conditions, such as during the day, alternate embodiments can incorporate the use of secondary attractants to attract the insects. These secondary attracts can include, but are not limited to attractants that: 1) release a scent suitable for attracting insects; 2) release heat to attract insects; and 3) produce electrical signals at a particular frequency to attract insects.

We claim:

1. A method of trapping insects comprising:
directing an insect-attracting light through an inside surface of at least one translucent wall to an outer surface of the at least one translucent wall;
flowing a trapping fluid down the outer surface;
attracting insects towards the outer surface by the insect-attracting light and causing insects attracted thereto to come into direct contact with the trapping fluid; and
trapping the insects with the trapping fluid.

2. The method of claim 1, further comprising:
collecting trapped insects in a removable filter;
collecting the trapping fluid in a reservoir; and
recirculating the trapping fluid to the outer surface of the at least one translucent wall.

3. The method of claim 2, further comprising distributing the trapping fluid along an upper end of the at least one translucent wall for forming a fluid film on the outer surface of the at least one translucent wall.

4. An insect trap comprising:
at least one translucent wall having an inside surface, an outer surface and an upper end;
at least one light source located adjacent the inside surface of the at least one translucent wall for emitting insect-attracting light, visible to insects at the outer surface thereof;
a distributor for directing trapping fluid in a fluid film down the outer surface of the at least one translucent wall,
wherein the insects, attracted to the insect-attracting light, come into direct contact with the fluid film and are trapped by the trapping fluid.

5. The insect trap of claim 4 further comprising a reservoir for collecting the trapping fluid.

6. The insect trap of claim 5 further comprising a filter positioned between the outer surface of the at least one translucent wall and the reservoir for collecting trapped insects.

7. The insect trap of claim 6 wherein the filter is a removable screen.

8. The insect trap of claim 5, further comprising:
a housing; and
a base forming the reservoir for the trapping fluid, wherein
the housing is supported by the base and the trapping fluid is collected in the reservoir.

9. The insect trap of claim 8, further comprising a fluid recirculation pump for circulating the trapping fluid from the reservoir to the distributor.

10. The insect trap of claim 4, wherein the distributor comprises a plurality of orifices for directing the trapping fluid onto the outer surface of the at least one translucent wall.

11. The insect trap of claim 4, wherein the at least one translucent wall comprises one or more cylindrical translucent tubes.

12. The insect trap of claim 4, wherein the at least one translucent wall comprises at least two translucent walls.

13. The insect trap of claim 4, further comprising:
a housing formed of the at least one translucent wall and further comprising an additional wall or walls which are opaque.
